(19) United States
(12) Patent Application Publication
(10) Pub. No.: US 2007/0016516 A1
(43) Pub. Date: Jan. 18, 2007

(54) Method of supplemental funding of an insurance policy

(76) Inventor: Stan Mountford, San Jose, CA (US)

Correspondence Address: John P. Moran;Holland & Knight LLP, 2099 Pennsylvania Avenue, N.W., Washington, DC, 20006, US

(21) Appl. No.: 11/182,075

(22) Filed: Jul. 15, 2005

(51) Int. Cl. G06Q 40/00

(52) U.S. Cl. 705/38; 705/40

(57) ABSTRACT

A method of providing supplemental funding of an life insurance policy through a split-dollar loan arrangement. An employer loans an employee additional premiums to increase the values of the life insurance policy. To replace working capital or retained earnings diminished by the loan to the employee, the employer borrows from an outside lender securing the loan with the assignment it holds on the life insurance policy.

### BACKGROUND OF THE INVENTION

The present invention relates to mechanisms for funding life insurance policies, and more particularly to mechanisms for supplemental funding of life insurance policies. The present invention also relates to mechanisms that enable a company to replace, for example, working capital, and or, retained earnings when the company lends money to an employee to be used as, for example, additional premium to increase the values in a life insurance policy purchased by the employee.

### SUMMARY OF THE INVENTION

In an exemplary embodiment, the present invention provides a method of supplemental funding of an insurance policy wherein a loan to an employee of a company is secured by a collateral interest in a life insurance policy owned by the employee. To replace working capital, or retained earnings that have been diminished by the loan to the employee, the company borrows from an outside lender. As security for this loan, the company can re-assign its collateral interest in the life insurance policy, along with, if desired, assets of the company. In accordance with an embodiment of the present invention, the life insurance policy and the loan arrangements are structured to comply with IRS Tax Codes and U.S. Treasury Regulations. The loan(s) made by the company to the employee as additional premium significantly increase the values of the life insurance policy for the benefit of the employee.

In an exemplary embodiment, the present invention also provides a method of supplemental funding of an insurance policy that is owned by a first entity. Such a first entity can be, for example, an employee, a trust, a family member of the employee, a contractor, a director, or, an outside entity that receives compensation from the company. In this exemplary embodiment, the policy has base premiums that are owed to issue and maintain the policy. The insurance contract also allows for the payment of optional additional premiums for additional benefits under the insurance policy. The exemplary method includes, for example, providing a loan agreement from the employer (which can be, for example, a C or S corporation, a partnership, an LLC or a LLP) to the employee for payment of the additional premiums; receiving an interest in the insurance policy from the employee as security for the loan agreement; and paying the additional premiums under the loan agreement.

### BRIEF DESCRIPTION OF THE DRAWINGS

FIG. 1 schematically illustrates an example of a capital split-dollar insurance arrangement in accordance with an aspect of the present invention.

### DETAILED DESCRIPTION OF THE PREFERRED EMBODIMENTS

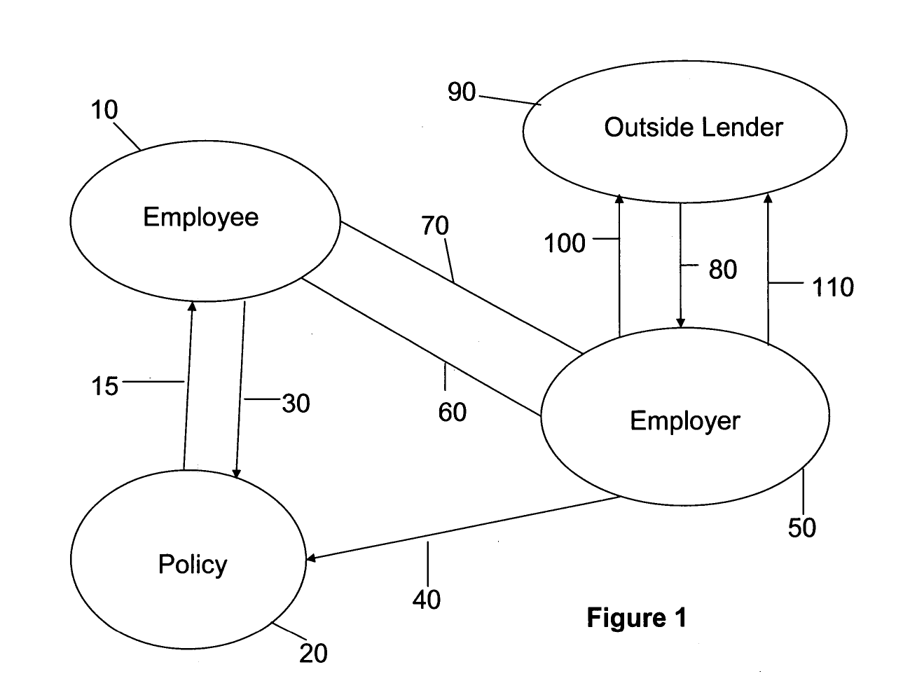

Referring to FIG. 1, an employee obtains an insurance policy 20 covering, for example, the employee's own life. The policy 20 can be any of a variety of types, including a universal life insurance policy or a whole life policy. Such policies typically require annual payments of base premiums 30, and provide for benefits 15, such as for example, a death benefit and cash values. The policy 20 also allows the payment of additional premiums 40.

As shown in the exemplary embodiment of FIG. 1, the additional premiums 40 can be paid by an employer 50, or directly from an outside lender to the issuer of the policy 20 on behalf of the employee 10. The number of additional premiums 40 that can be paid depends upon the terms of the policy 20. One non-limiting example number of additional premiums 40 is three additional premiums. The number can be set to any suitable number as agreed under the policy. In the illustrative embodiment, the additional premiums 40 can be used under the terms of the policy 20 to purchase additional death benefit to be added to the policy 20. The employer 50 can provide the funds for the additional premiums 40 to the employee 10 who subsequently pays the additional premiums.

Paying additional premiums 40 can significantly increase both the cash value of the policy 20 and its death benefit over the amounts that would be provided by the payment of the base premiums 30 alone. Paying the addition premiums 40 typically increases the cash value and death benefit of the policy 20 by amounts that are generally greater than the death benefit and cash values that the issuing insurance carrier would offer under a separate permanent policy on the employee's life for the payment of an amount of premiums equal to the additional premiums 40.

In accordance with an example embodiment of the present invention, the policy 20 is issued to and owned by the employee 10; and the employee 10 is solely responsible for and pays the base premiums 30 as they become due. The employee 10 may enter into an arrangement with the employer 50 whereby the employer 50 will deduct the base premiums 30 from the compensation that would otherwise be payable to the employee 10 and pay that amount directly to the insurance carrier on his behalf as, for example, the employee's agent. If, in such an arrangement, the employer 50 pays the base premiums 30, the employee would report the amounts paid to the carrier on his behalf as ordinary income. In any event, the employee pays the base premiums 30, either directly or through the arrangement with the employer 50 such as just described, for an initial period, such as for at least the first seven years that the policy 20 is in force.

In accordance with one aspect of an embodiment of the present invention, the employer 50 and the employee 10 can enter into a split-dollar interest-free, or interest bearing loan agreement 60 (“split-dollar agreement 60”) and a collateral assignment 70. Under the split-dollar agreement 60, the employer 50 can pay the additional premiums 40 to the insurance carrier on behalf of the employee 10, or arrange for the outside lender to pay the additional premiums 40 directly to the insurance company. As summarized above, the additional premiums 40 result in increasing the death benefit and cash value of the policy 20. Each additional premiums 40 payment made by the employer 50 to the insurance company is, in accordance with this embodiment of the invention, treated as either an interest-free, or interest bearing loan to the employee 10. The split-dollar agreement 60 can provide that the cumulative amounts loaned as additional premium to the employee 10 (“repayment amount”) is to be repaid to the employer 50 from the proceeds of the policy 20 in the event of the death of the employee 10, or from the cash value of the policy 20 if the arrangement with the employee 10 is otherwise terminated.

Furthermore, the split-dollar agreement 60 will provide that, so long as the arrangement with the employee 10 remains in effect, the employee 10 may not withdraw funds from the cash value or borrow from the policy 20. Additionally, the employee 10 should not borrow from the policy 20 before the end of the seventh year the policy 20 has been in effect, even if the arrangement with the employer has been terminated.

In accordance with another aspect of a preferred embodiment the repayment amount is secured by a security interest in the policy 20 to the employer 50 by the collateral assignment 70. The collateral assignment 70 can provide, as can the split-dollar agreement 60, that the repayment amount will first be paid to the employer 50 from the proceeds of the policy 20 in the event of the employee 10's death, or from the cash surrender value in the event the arrangement with the employee 10 is terminated for some other reason prior to the death of the employee 10. It is envisioned by the preferred embodiments that the collateral assignment 70 only creates a lien or security interest in favor of the employer 50 and does not result in a transfer of an ownership interest in the policy 20 (or any part thereof) to the employer 50 As a result, the employer 50 does not have incidents of ownership in the policy 20, such as, without limitation: a right to withdraw the cash surrender value; a right to borrow on the policy 20; or a right to designate beneficiaries of the proceeds as a result of the collateral assignment 70.

In accordance with the preferred embodiments, the split-dollar agreement 60 and the collateral assignment 70 remain in effect until, after the termination of the arrangement with the employee 10, the obligation to the employer 50 under the split-dollar agreement 60 and the collateral assignment 70, e.g., payment of the repayment amount, has been satisfied in full.

One example of a mechanism for funding the payment of the additional premiums 40, the employer 50 can borrow an amount via a loan 80 from a third party, such as an outside lender 90. One non-limiting example of an outside lender 90 is the insurance carrier that issued the policy 20 as collateral. The loan 80 can have any desired form. For example, the loan 80 can be evidenced by one or more negotiable promissory notes 100 with a fixed term of repayment having a rate of interest and other terms which could be obtained from any independent third-party commercial lender. In particular: it is anticipated that in accordance with an embodiment of the present invention, the loan 80 can be a full recourse obligation of the employer 50; it is preferably not a policy loan; the loan would be subject to the outside lender's determination of the employer's credit worthiness; and the terms of repayment will be independent of the terms of the arrangements with the employee 10, the split-dollar agreement 60 and the collateral assignment 70. As is common, the promissory note or notes 100 may allow the prepayment of principal and interest.

To secure the loan 80, the employer 50 can assign to the outside lender 90 all of the rights of the employer 50 under the collateral assignment 70 via a reassignment 110. However, it is preferable that neither the terms of the loan 80 nor the reassignment 110 condition the obligation of the employer 50 to pay the loan 80. For example, it is preferred that neither the loan 80 nor the reassignment 110 condition the employer's obligation on any event which, under the terms of the arrangements with the employee 10, the split-dollar agreement 60 or the collateral assignment 70, would result in repayment to the employer 50 of the repayment amount or would enable the employer 50 to exercise its rights to the collateral under the collateral assignment 70. The rights of the outside lender 90 under the reassignment 110 should, in accordance with a preferred embodiment, be superior to those of the employer 50 under the collateral assignment 70, but the outside lender 90 should not obtain greater rights under the reassignment 110 than the employer 50 has under the collateral assignment 70.

The arrangements with the employee 10 can, in accordance with a preferred embodiment, terminate on the death of the employee 10, the termination of the employee's employment with the employer 50, after notice to terminate given by either the employee 10 or the employer 50, the surrender of the policy 20 by the employee 10 or the failure of the employee 10 to pay one of the base premiums 30. In the event of the employee's death, the policy 20 proceeds can be, to the extent of the repayment amount, used to repay any remaining unpaid balance of the loan 80 to the outside lender 90, as a repayment of the amount owed by the employee 10 to the employer 50 under the split-dollar agreement 60. If the repayment amount is greater than the unpaid balance of the loan 80, that excess can be repaid to the employer 50. Thereafter, the remaining proceeds will be paid to the employee 10's designated beneficiary. If the repayment amount is less than the amount owing on the loan 80, the employer 50 will be responsible for the payment of any deficiency.

If the arrangements with the employee 10 terminate for some reason other than the death of the employee 10, the employer 50 can use the repayment amount to repay any remaining unpaid balance of the loan 80 to the outside lender 90, and any excess of the repayment amount over that balance will be retained by the employer 50. Repayment of the loan 80 and/or the repayment amount may be funded with a withdrawal from the cash value of the policy 20 or, if the policy 20 has been in effect for at least a minimum period such as seven years, a policy loan on the policy 20. The outside lender's lien and the employer's subordinate lien against the policy 20 would then be released.

The following outlines an embodiment of the present invention in which the employer 50 is a corporation duly organized, existing and in good standing under the laws of the state of its incorporation. In this example, it is assumed that the employer 50 is a domestic corporation within the meaning of § 7701(a)(4) of the Internal Revenue code of 1986, as amended (“IRC”); it may be taxed as either a “C corporation” within the meaning of IRC § 1361(a)(2) or an “S corporation” within the meaning of IRC § 1361(a)(1). Under such circumstances, it is contemplated that if the employer 50 is an S corporation:

1. For all taxable years during which the arrangements with the employee 10 are in effect, the employer 50 will be an S corporation within the meaning of IRC § 1361(a)(1) for the entire year;

2. At all times during which the arrangements with the employee 10 are in effect, all activity in which the employer 50 is involved constitutes an active trade or business and not a passive activity within the meaning of IRC § 469; and

3. At all times during which the arrangements with the employee 10 are in effect, the S corporation does not engage in any activities that are not engaged in for profit.

As will be understood by those skilled in the art, the interest amounts attributable to the interest free loan that are foregone by the employer 50 will be accounted for in accordance with IRC § 7872 and Treas. Reg. § 1.7872-15, and any other taxable benefits provided by the arrangements with the employee 10 will be included in the employee's compensation and reported by the employer 50 on applicable withholding statements. The employer 50 should normally withhold all applicable amounts to the extent necessary. Also, it is understood that all compensation paid by the employer 50 to the employee 10, including the foregone interest amounts and any premiums 30 paid by the employer 50 as compensation to the employee 10, will be reasonable. As an additional consideration, it is desirable that the policy 20 not be classified as a single premium policy under IRC § 264(a)(2) and (b). Accordingly, the sum of the base premiums 30 and the additional premiums 40 paid during the first four years that the policy 20 is in effect should not exceed 65% of the total anticipated premium payments due under the policy 20 during the maximum life of the policy. In addition, it is preferable that no more than 3 years of additional premiums 40 will be borrowed in the first 7 policy years so that the policy will comply with the “safe harbor” provision known as the “4-out-of-7 rule” as contained in IRC § 264(d)(1). The policy 20 should preferably qualify as a “life insurance contract” under IRC § 7702, and not either a modified endowment contract as defined under IRC § 7702A, or any part of any group-term life insurance plan described in IRC § 79.

1. A method of supplemental funding of an insurance policy by a second entity for the benefit of a first entity, wherein the insurance policy has premiums that are owed and optional additional premiums for additional benefits under the insurance policy, including:
providing a loan agreement to the first entity for payment of the additional premiums;
receiving an interest in the insurance policy from the first entity as security for the loan agreement; and
paying the additional premiums under the loan agreement.

2. A method of supplemental funding of an insurance policy according to claim 1, wherein the paying the additional premiums includes, paying an amount as additional premiums on behalf of the first entity.

3. A method of supplemental funding of an insurance policy according to claim 1, wherein the paying the additional premiums includes, paying an amount as additional premiums to the first entity who subsequently pays the additional premium.

4. A method of supplemental funding of an insurance policy according to claim 1, wherein the paying the additional premiums includes, the second entity paying the additional premiums on behalf of the first entity

5. A method of supplemental funding of an insurance policy according to claim 1, wherein a second entity receives the interest in the insurance policy, and the interest includes a lien in favor of the second entity.

6. A method of supplemental funding of an insurance policy according to claim 1, further including:
a second entity obtaining a loan a third party to pay the additional premiums; and
the second entity assigning the interest it holds in the insurance policy to the third party as security for the loan.

7. A method of supplemental funding of an insurance policy according to claim 1, where the receiving the interest in the insurance policy includes receiving the interest in the insurance policy in the form of a collateral assignment.
